(19) United States
(12) Patent Application Publication
(10) Pub. No.: US 2012/0047802 A1
(43) Pub. Date: Mar. 1, 2012

(54) Invertomato dual purpose invertible planter

(76) Inventor: Michael Patrick Murray, Bolton, MA (US)

(21) Appl. No.: 12/927,179

(22) Filed: Nov. 9, 2010

Related U.S. Application Data
(60) Provisional application No. 61/402,419, filed on Aug. 30, 2010.

(51) Int. Cl. A01G 9/02

(52) U.S. Cl. 47/67; 47/65.5

(57) ABSTRACT

One embodiment of a dual purpose Planting System allows for the growth of plants in an upright position and also allows for the growth of inverted or upside down plants. One embodiment of a dual purpose Planting System allows for the growth of plants in an upright position until after the plants have reached early maturity or maturity and begin to suffer the effects of gravity as a result of sheer size, legginess or vegetable growth. At this point the much larger, stronger plants—when inverted—will have greater access to sunlight or other light sources (and therefore the process of photosynthesis) as a result of the sheer size of the plant in relation to the planter and its position between the sun and the larger plant.

### CROSS-REFERENCE TO RELATED APPLICATIONS

This application claims the benefit of provisional patent application No. 61/402,419 filed 26 Aug. 2010 by the present inventor.

### FEDERALLY SPONSORED RESEARCH

Not Applicable

### SEQUENCE LISTING OR PROGRAM

Not Applicable

### BACKGROUND

1. FIELD

This application relates to vegetable planting systems.

2. PRIOR ART

Planters and planting systems allow for the growth of plants in areas not typically lending to agriculture. The strength of any planter is the ability to grow plants in areas not otherwise prone to agriculture and to create a moveable and or hangable growing area. Planters and planting systems also provide significant esthetic benefits.

The critical weakness to any upright planter, specifically with leggy or viney plants such as tomatoes or peppers is need to continuously support, stake, cage and otherwise care for a plant that often collapses as a result of the effect of gravity on the plant itself or on the plant laden with heavy fruits or vegetables.

Inverting the growing process at some time after germination obviates the need for supplemental or ineffective support systems, staking, caging and weeding. Plant inversion allows gravity to act as an aid to growth and productivity rather than a hindrance.

One planting system has created a planter for growing plants upside down in which the inversion process is completed at the seedling, adolescent or nascent stages of the plant's lifecycle. U.S. Pat. No. 6,874,278 to Felknor discloses a simple design for growing plants upside down from the earliest stages of the plant's lifecycle.

Thus if this design (U.S. Pat. No. 6,874,278) is used, a seedling, soon after germination or early in the lifecycle, is inserted at the bottom of U.S. Pat. No. 6,874,278 through a small hole in a plastic disc attached to the bottom of a plastic bag.

Thus if this design (U.S. Pat. No. 6,874,278) is used the seedling plant must be transplanted from another planting mechanism or system.

Growing plants in an upside down or inverse position as a seedling, from adolescence or during the nascent stages of growth, retard and restrict the growing process (See FIG. 1 to U.S. Pat. No. 6,874,278 to Felknor). Inverted adolescent plants will immediately begin to suffer the effects of photosynthesis deprivation. The immature plants will bend, warp or retard in a struggle to grow upward toward the sun or other light source to achieve the process of photosynthesis. (See FIG. 1 to U.S. Pat. No. 6,874,278 to Felknor).

Despite bending, warping and retarding growth, adolescent plants will be deprived significantly of sunlight, the process of photosynthesis and growth during the period of time that the sun or light source is directly overhead and therefore blocked by the position of the planter system (U.S. Pat. No. 6,874,278) directly above the adolescent plant between the plant and the sun or other light source.

Further, the light source is blocked limiting the process of photosynthesis during the periods of the day when the sun is strongest, providing the greatest source of energy and growth to young plants.

U.S. Pat. No. 6,874,278 to Felknor is manufactured from inexpensive plastic film and the design does not allow for the growth of plants in an upright position.

The InverTomato™ Dual Purpose Invertible Planting System allows for the growth of plants in an upright position.

The InverTomato™ Dual Purpose Invertible Planting System also allows for the growth of plants in an upright position until after the plants have reached early maturity or maturity and begin to suffer the effects of gravity as a result of sheer size, legginess or vegetable growth. At this point the much larger, stronger plants—when inverted—will have greater access to sunlight or other light sources (and therefore the process of photosynthesis) as a result of the sheer size of the plant in relation to the planter and its position between the sun and the larger plant.

The InverTomato™ Dual Purpose Invertible Planting System with Removable, Interlocking, Pivoting Base with Aligning Canals (or slots) is a planter system consisting of a planter pot with a Removable, Interlocking, Pivoting Base with Aligning Canals (or slots) a steel support rim and a treble chain suspension system. The planter system can take many shapes and sizes but is most often in the shape of a normal planter, planting pot, conical or tubular. The embodiment can be made of a variety of materials including plastic, clay and metal. The entire base or bottom can be removed and interlocks with the bottom of the planter system. The bottom unit consists of paired, Removable, Interlocking, Pivoting Base Discs with Aligning Canals (or slots).

The InverTomato™ Planter allows any type of plant capable of being grown in a planter to be grown to adolescence or early maturity first upright. Thereafter, the stronger, healthier plant may be removed from the planter, the Removable, Interlocking, Pivoting Base with Aligning Canals (or slots) may be taken from the bottom of the planter where they were positioned below the root system and may be placed around the stem of the plant just above the root system (rather than below the root system when grown upright) by aligning the canals in the removable, pivoting, interlocking base discs, placing the base of the stem in the center of the aligned canals in the discs and then rotating or pivoting the discs to lock in the stem at the base of the plant. Then the plant may be inverted through the large opening in the planter bottom created by the removal of the plant and the Removable, Interlocking, Pivoting Base with Aligning Canals (or slots). The Removable, Interlocking, Pivoting Base with Aligning Canals (or slots) will then lock into place with the interior base of the InverTomato Planter allowing the plant to be inverted or hung upside down. The embodiment is manufactured with a treble chain or cable suspension system allowing the embodiment to be suspended or hung from a hook or other base structure.

Thus, several advantages of the embodiment are as follows: The embodiment may be used as a normal planter, hanging planter or planting pot allowing plants to be grown upright. The embodiment may also be used as a normal planter, hanging planter or planting pot allowing plants to be grown upright allowing for the growth of plants in an upright position until after the plants have reached early maturity and begin to suffer the effects of gravity as a result of sheer size, legginess or vegetable growth. At the point when gravity affects the structure of the plant, the embodiment allows for the mature plant to be inverted during maturity. At this point, despite inversion, the much larger, stronger, healthier plants will have greater access to sunlight or other light sources and therefore the process of photosynthesis as a result of the sheer size of the plant in relation to the planter and its position between the sun and the larger plant. This embodiment results in larger, healthier, faster growing more productive plants. This embodiment results in ease of inversion of a mature plant. The embodiment can be manufactured in a variety of standard shapes and sizes engineered to grow a variety of plants in a variety of settings. The embodiment is durable and easily storable.

### SUMMARY

In accordance with one embodiment the InverTomato™ Dual Purpose Invertible Planting System is an open ended planting system with a Removable, Interlocking, Pivoting Base with Aligning Canals (or slots) allowing plants to be grown upright, while also allowing mature plants to be inverted at later stages of growth allowing for greater access to sunlight and photosynthesis while young and therefore, enhancing the growth process. The embodiment is manufactured with a treble chain or cable system allowing the embodiment to be suspended or hung from a hook or other base structure.

### DRAWINGS

FIG. 1 Shows whole and cross sectional or transparent views of the embodiment with the plant grown upright to maturity.

Reference Numeral 10 Shows the exterior of the embodiment.

Reference Numeral 11 Shows the notches in the embodiment for the support ring.

Reference Numeral 12 Shows any plant grown upright to maturity or early adolescence in the embodiment.

Reference Numeral 13 Shows notch in the hidden support ring.

Reference Numeral 14 Shows the Removable, Interlocking, Pivoting Base with Aligning Canals (or slots).

Reference Numeral 15 Shows a cross section close-up of the Removable, Interlocking, Pivoting Base with Aligning Canals (or slots), interlocking with each other and the interior base of the embodiment—when upright and or inverted.

Reference Numeral 16 Shows the exposed root system of a grown plant.

FIG. 2 Shows the removal of the plant from the embodiment as the first step in the inversion process.

Reference Numeral 20 Shows the exposed root system of any plant when removed from the embodiment.

Reference Numeral 14 Shows the Removable, Interlocking, Pivoting Base with Aligning Canals (or slots), removed from the embodiment.

Reference Numeral 22 Shows the large opening or pass-through in the embodiment created by the removal of the plant and the Removable, Interlocking, Pivoting Base Discs with Aligning Canals (or slots).

FIG. 3 Shows one method of plant inversion.

Reference Numeral 30 Shows the reshaped exposed root system.

Reference Numeral 14 Shows the Removable, Interlocking, Pivoting Base Discs with Aligning Canals (or slots) being locked around the stem at the base of the root system between the root system and the foliage and the direction of alignment.

Reference Numeral 12 Shows the inverted plant just above the embodiment and the direction of inversion through the large opening or pass-through created by the removal of the plant and the Removable, Interlocking, Pivoting Base with Aligning Canals (or slots).

Reference Numeral 32 Shows a close up of the exposed reshaped inverted root system with the Removable, Interlocking, Pivoting Base Discs with Aligning Canals (or slots) locked around the stem of the plant at the base.

FIG. 3b Shows and alternative method of plant inversion in which the root system is guided through the large opening or pass-through created by the removal of the plant and the Removable, Interlocking, Pivoting Base with Aligning Canals (or slots).

Reference numeral 30 shows the reshaped inverted exposed root system.

Reference numeral 12 shows the inverted plant and direction of inversion.

Reference numeral 14 shows the Removable, Interlocking, Pivoting Base Discs with Aligning Canals (or slots) and the direction in which they are locked around the stem of the plant at the base, between the exposed root system and the foliage.

FIG. 4 Shows the embodiment containing the inverted plant.

Reference Numeral 12 Shows the inverted plant.

Reference Numeral 10 Shows the embodiment.

Reference Numeral 13 Shows the notch in the hidden support ring.

Reference Numeral 11 Shows the notches in the embodiment for the support ring.

Reference Numeral 40 Shows the treble support chain.

Reference Numeral 41 Shows the InverTomato funnel cap.

FIG. 5 Shows a cross section of the InverTomato funnel cap.

Reference Numeral 41 Shows a cross section of the InverTomato funnel cap.

Reference Numeral 40 Shows the treble support chain.

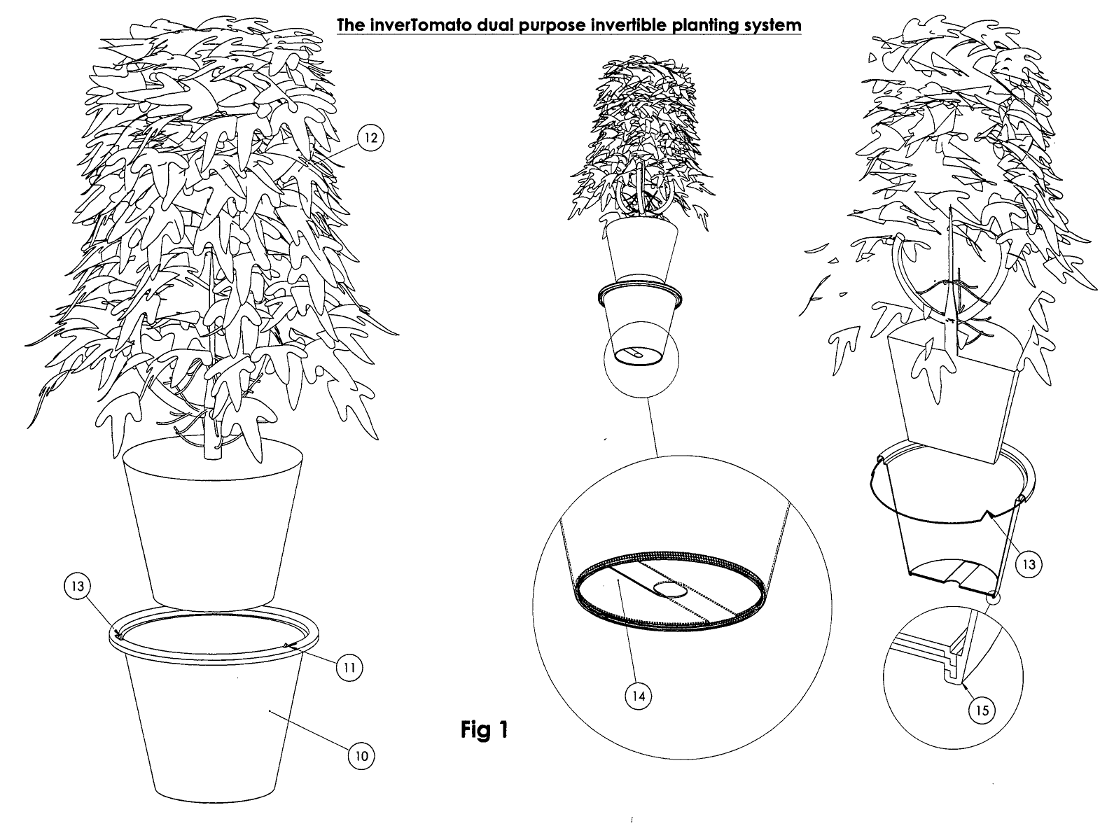

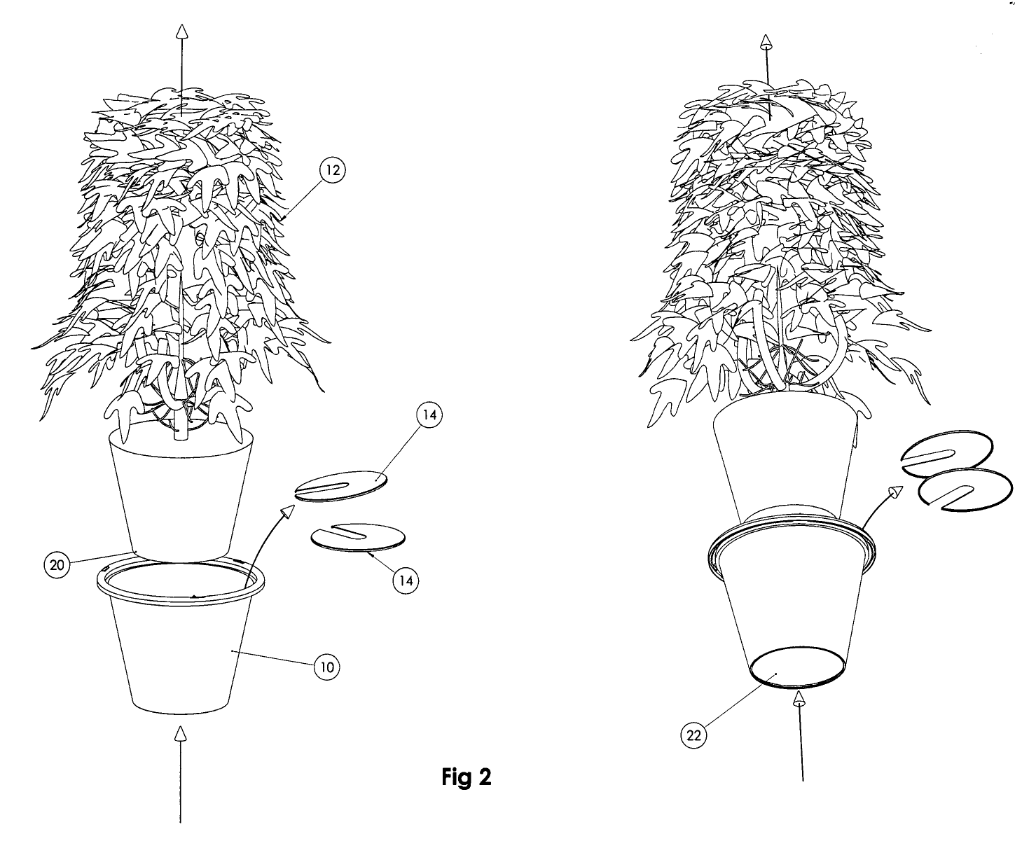

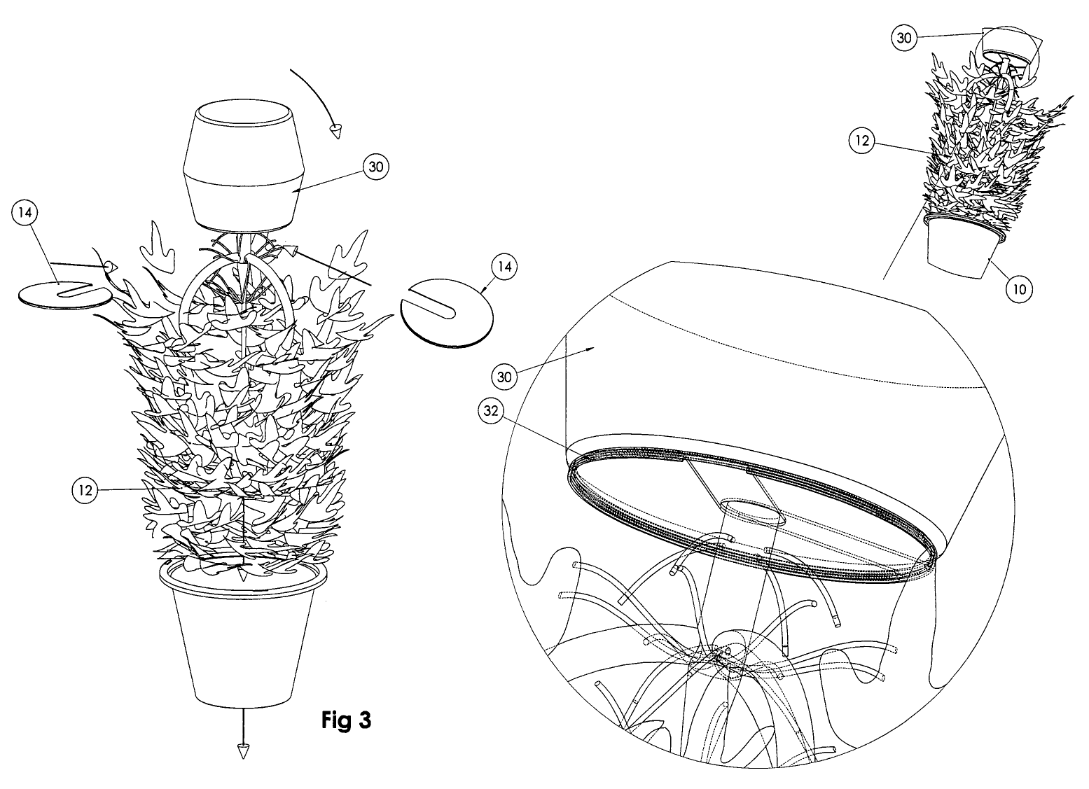

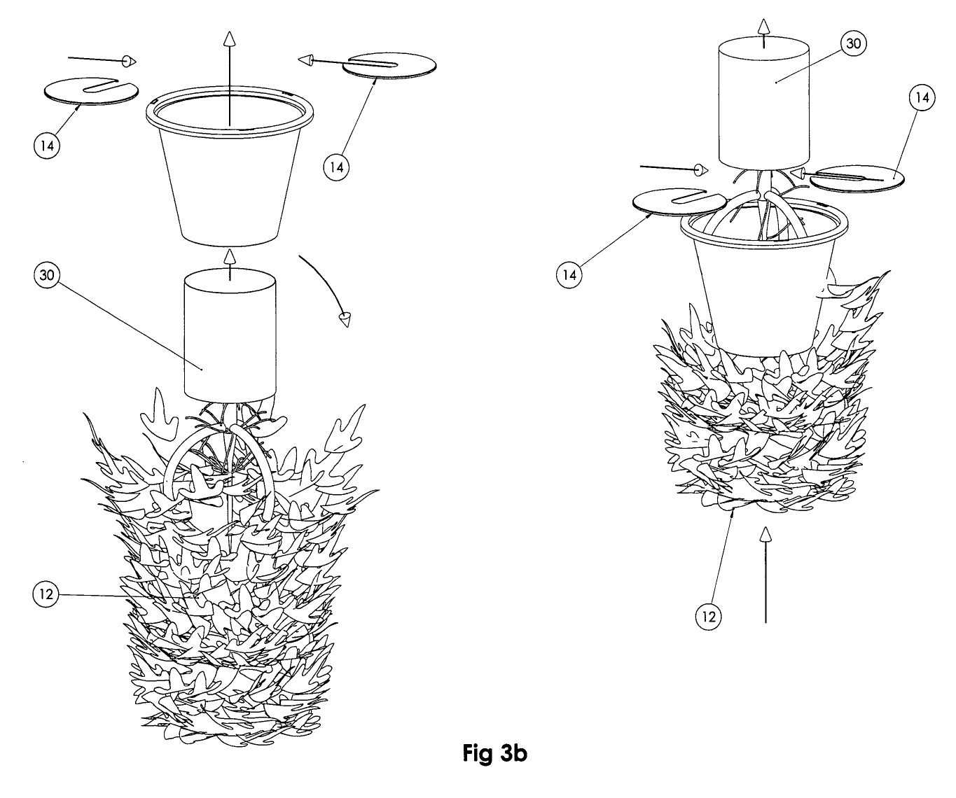

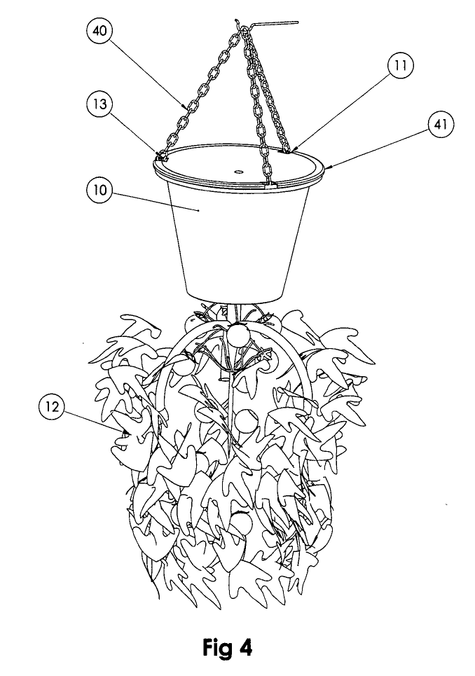

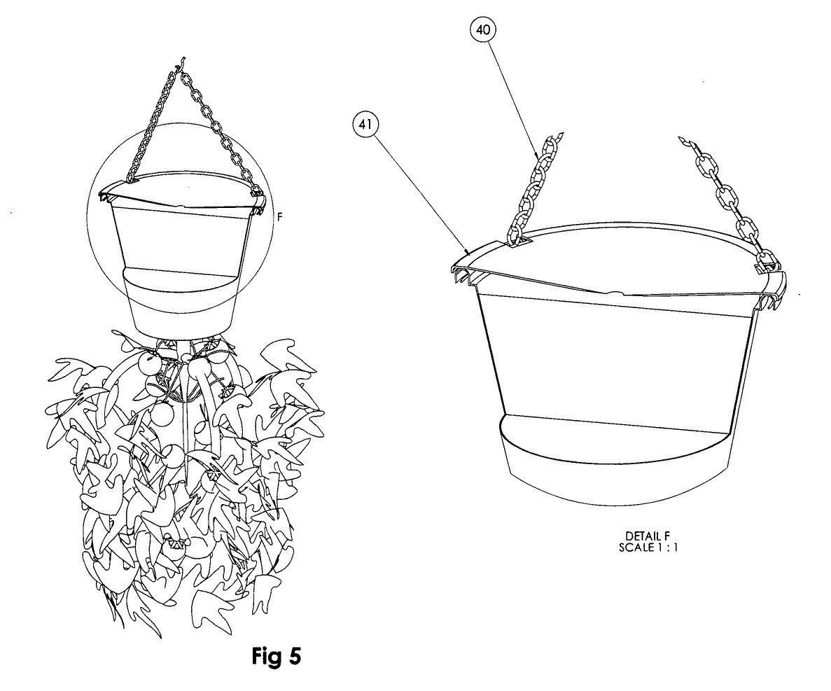

### DETAILED DESCRIPTION: FIGS. 1, 2, 3, 3b, 4 & 5

The drawing of one manifestation of the embodiment is enclosed in FIG. 1. The InverTomato™ Dual Purpose Invertible Planting System allows for the growth of plants in an upright position (FIG. 1).

The InverTomato™ Dual Purpose Invertible Planting System also allows for the growth of plants in an upright position (FIG. 1) until after the plants have reached early maturity and begin to exhibit the effects of gravity as a result of sheer size and legginess or vegetable growth. At this point the much larger, healthier plants—when inverted—will have greater access to sunlight or other light sources (and therefore the process of photosynthesis) as a result of the sheer size of the plant in relation to the planter and its position between the sun and the larger plant (Reference Numeral 12—FIG. 1).

Thereafter, the larger, stronger plant may be removed from the planter (FIG. 2), the removable, pivoting, interlocking base discs may be taken from the bottom of the planter where they were positioned below the root system (Reference Numeral 14—FIG. 2) and may be placed around the stem of the plant just above the root system (FIGS. 3 and 4) (rather than below the root system when grown upright) by aligning the canals in the removable, pivoting, interlocking base discs, placing the base of the stem in the center of the aligned discs and then rotating or pivoting the discs to lock in the base of the plant (Reference Numeral 14 and 32—FIG. 3).

Then the plant may be inverted and guided through the large opening in the planter bottom created by the removal of the plant and the Removable, Interlocking, Pivoting Base Discs with Aligning Canals (or slots) (FIGS. 3 and 4). When lowered, the Removable, Interlocking, Pivoting Base with Aligning Canals (or slots) will then lock into place with the interior base of the InverTomato™ Planter (Reference Numeral 15—FIG. 1) allowing the plant to be suspended upside down (FIG. 4).

An alternate method of plant inversion can be achieved by reshaping the root system (Reference Numeral 30—FIG. 3b) and guiding the inverted root system through the large opening or pass-through created by the removal of the plant and Removable, Interlocking, Pivoting Base Discs with Aligning Canals (or slots) and guiding the root system through the bottom of the embodiment toward the top (FIG. 3b).

Then the Removable, Interlocking, Pivoting Base Discs with Aligning Canals (or slots) may be locked around the stem of the plant (Reference Numeral 14—FIG. 3b) by aligning the canals (or slots) in the Removable, Interlocking, Pivoting Base Discs, placing the base of the stem in the center of the aligned discs and then rotating or pivoting the discs to lock in the base of the plant (Reference Numerals 14, and 32—FIGS. 3 and 3b). The plant may then be re-lowered into the embodiment and the removable, pivoting, interlocking base discs will then lock into place with the interior base of the embodiment Planter (Reference Numeral 15—FIG. 1) allowing the plant to be suspended upside down (FIG. 4).

The embodiment is manufactured with a funnel cap allowing all rainwater to be collected and delivered to the center of the root system while also locking in moisture and protecting the root system from the rapid evaporation of water. The funnel cap also suppresses the growth of weeds (Reference Numeral 41—FIG. 4).

The embodiment is manufactured with a treble chain or cable suspension system allowing the embodiment to be suspended or hung from a hook or other base structure (Reference Numeral 11, 13 and 40—FIG. 4).

The embodiment can be manufacture in many shapes sizes and colors.

### Alternative Embodiments

The embodiment contained in FIGS. 1-5 may also be manufactured with two identical interlocking bottom discs rather than dual pivoting discs with aligning canals. The dual disc construction allows for one disc to enclose the bottom of the embodiment while the plant is grown upright, the second disc is placed around the base of the adolescent plant while grown upright. At maturity the plant may be inverted through the large opening at the bottom of the planter. The second disc grown at the base of the upright plant will then lock into the bottom of the embodiment when inverted allowing for the hanging of the inverted plant.

The embodiment contained in FIGS. 1-5 may also be manufactured with a hinged locking base with a single canal or with hinged sides.

### Advantages:

From the description above several advantages of the embodiment are as follows:

The embodiment may be used as a normal planter, hanging planter or planting pot allowing plants to be grown upright.

The embodiment may also be used as a normal planter, hanging planter or planting pot allowing plants to be grown in the upright position until after the plants have reached early maturity or maturity and begin to suffer the effects of gravity as a result of sheer size and legginess or vegetable growth. At the point when gravity affects the structure of the plant, the embodiment allows for the mature plant to be easily inverted during maturity through the large opening at the bottom of the embodiment created by the removal of the plant and Removable, Interlocking, Pivoting Base Discs with Aligning Canals (or slots).

At this point the much larger, healthier inverted plants will have greater access to sunlight or other light sources and therefore the process of photosynthesis as a result of the size of the plant in relation to the planter and its position between the sun and the larger plant.

This embodiment results in larger, healthier, faster growing plants.

This embodiment results in more productive inverted plants.

This embodiment results in ease of inversion of a mature plant.

This embodiment does not require the plant to be transplanted from another mechanism or system. Any plant may spend its entire lifecycle in this embodiment.

The embodiment can be manufactured in a variety of standard shapes, sizes, colors and designs and is engineered to grow a variety of plants in a variety of settings.

The embodiment is durable and easily storable.

The embodiment typically consisting of a traditional planter style and shape is more esthetically pleasing than the plastic, foam or other sacks used for inversion.

The embodiment provides a much easier and more effective method of plant inversion.

The embodiment can be manufacture from a variety of substances not limited to plastic, metal and clay.

### CONCLUSION, RAMIFICATIONS & SCOPE

Thus the reader will see from the embodiment that the embodiment will, at least, significantly enhance the growth process, productivity and ease of inversion of potable invertible plants.

Thus the reader will see from the embodiment that the embodiment performs the functions of at least two planters as the embodiment may be used solely as an upright planter or the embodiment may be used as an inverted planter and the embodiment may be used as a hanging planter.

While my above description contains many specificities, these should not be used as limitations on the scope, but rather as an exemplification of one preferred embodiment thereof. Many other variations are possible. For example, the embodiment can be in the form of many different shapes and sizes and may be used for the growth of any plant including the growth of plants in the upright position.

Accordingly the scope should be determined not by the embodiments illustrated but by the claims and their legal equivalents.

I claim:

1. A Planter or planting system with a removable bottom creating a large opening, hole or pass through at the base of the embodiment allowing for the inversion of larger, adult or adolescent plants; and

2. The embodiment or plant growing device in claim 1, further including Removable, Interlocking, Pivoting Base Discs with Aligning Canals (or slots) or dual removable interlocking bottoms allowing for the interlocking base discs to be locked around the stem at the base of an adult or adolescent plant; and

3. The embodiment or plant growing device in claims 1 and 2 with Removable, Interlocking, Pivoting Base Discs with Aligning Canals (or slots) that interlock or pair with each other and interlock or pair with the bottom of the main embodiment structure; and

4. A dual purpose planter allowing plants to be both grown upright and or allowing plants to be inverted and suspended or hung upside down; and

5. The system of growing a plant or plants in an upright position until adolescence or adulthood and thereafter inverting the larger plants to better utilize sunlight or other sources of light and therefore maximize the process of photosynthesis and productivity.
